(19) United States
(12) Patent Application Publication
(10) Pub. No.: US 2025/0018801 A1
(43) Pub. Date: Jan. 16, 2025

(54) Commercial Electric Vehicle Braking Systems

(71) Applicant: Harbinger Motors Inc., Garden Grove, CA (US)

(72) Inventors: Jue Wang, Temple City, CA (US); Alexi Charbonneau, Redondo Beach, CA (US)

(21) Appl. No.: 18/903,970

(22) Filed: Oct. 1, 2024

Related U.S. Application Data
(63) Continuation-in-part of application No. 18/463,119, filed on Sep. 7, 2023, now abandoned.
(60) Provisional application No. 63/374,865, filed on Sep. 7, 2022.

(51) Int. Cl. B60L 7/26; B60L 1/00; B62D 63/04

(52) U.S. Cl. CPC B60L 7/26; B60L 1/003; B62D 63/04; B60L 2250/26; B60L 2270/00

(57) ABSTRACT

Described herein are methods and systems for operating a braking system of a commercial electric vehicle. In various embodiments, the braking system may include a plurality of electric brake control modules. The electric brake control modules may be configured to operate the brakes on different axles of the vehicle. One or more of the electric brake control modules may be configured to detect a fault with another electric brake control module and operate the brakes of the vehicle accordingly.

### CROSS-REFERENCE TO RELATED APPLICATION

This application is a continuation-in-part of U.S. patent application Ser. No. 18/463,119, entitled “Commercial Electric Vehicle Braking Systems” and filed on 2023 Sep. 7, which claims the benefit under 35 U.S.C. § 119 (e) of U.S. Provisional Patent Application No. 63/374,865, entitled “Commercial Electric Vehicle Braking Systems” and filed on 2022 Sep. 7, both of which are incorporated herein by reference in their entirety for all purposes.

### BACKGROUND

Commercial vehicles typically utilize hydraulic braking systems. Brake-by-wire systems are controlled by an electronic control unit (ECU), but failure of such an ECU may cause brake system failure. As reliability is paramount in commercial vehicles, friction brake systems are operated with traditional hydraulic systems instead of brake-by-wire systems. However, such traditional hydraulic systems do not provide for real-time bias adjustment.

### SUMMARY

Described herein are braking systems and vehicles including braking systems. In a first embodiment, a system includes a first pedal position sensor, a first brake, a first electronic brake control module, a second brake, and a second electronic brake control module. The first pedal position sensor configured to detect a position of a brake pedal and provide first pedal position data. The first electronic brake control module configured to: receive the first pedal position data; determine that the first pedal position data indicates a braking request; determine, based on the first pedal position data, a first brake torque target and a primary second brake torque target; operate the first brake based on the first brake torque target; and communicate, to a second electronic brake control module, the primary second brake torque target. The second electronic brake control module configured to: receive the primary second brake torque target; and operate the second brake based on the primary second brake torque target.

In a second embodiment, a vehicle includes a chassis, a first wheel/tire assembly coupled to the chassis, a second wheel/tire assembly coupled to the chassis, a pedal, a first pedal position sensor, a first brake, a first electronic brake control module, a second brake, and a second electronic brake control module. The first pedal position sensor configured to detect a position of the pedal and provide first pedal position data. The first brake configured to brake the first wheel/tire assembly. The first electronic brake control module configured to: receive the first pedal position data; determine that the first pedal position data indicates a braking request; determine, based on the first pedal position data, a first brake torque target and a primary second brake torque target; operate the first brake based on the first brake torque target; and communicate, to a second electronic brake control module, the primary second brake torque target. The second brake configured to brake the second wheel/tire assembly. The second electronic brake control module configured to: receive the primary second brake torque target; and operate the second brake based on the primary second brake torque target.

In a third embodiment, a system includes a first electronic brake control module and a second electronic brake control module. The first electronic brake control module configured to: receive first pedal position data from a first pedal position sensor; determine that the first pedal position data indicates a braking request; determine, based on the first pedal position data, a first brake torque target and a primary second brake torque target; operate a first brake based on the first brake torque target; and communicate, to a second electronic brake control module, the primary second brake torque target. The second electronic brake control module, configured to: receive the primary second brake torque target; and operate the second brake based on the primary second brake torque target.

These and other embodiments are described further below with reference to the figures.

### Clauses

Clause 1. A system comprising: a first pedal position sensor, configured to detect a position of a brake pedal and provide first pedal position data; a first brake; a first electronic brake control module, configured to: receive the first pedal position data; determine that the first pedal position data indicates a braking request; determine, based on the first pedal position data, a first brake torque target and a primary second brake torque target; operate the first brake based on the first brake torque target; and communicate, to a second electronic brake control module, the primary second brake torque target; a second brake; and a second electronic brake control module, configured to: receive the primary second brake torque target; and operate the second brake based on the primary second brake torque target.

Clause 2. The system of clause 1, further comprising: a second pedal position sensor, configured to detect the position of the brake pedal and provide second pedal position data, wherein the second electronic brake control module is further configured to: receive the second pedal position data; determine that the second pedal position data indicates the braking request; and cross-check the second brake torque target based on the second pedal position data.

Clause 3. The system of clause 2, wherein the second electronic brake control module is configured to: determine a first electronic brake control module fault; determine an alternative second brake torque target; and operate the second brake based on the alternative second brake torque target.

Clause 4. The system of clause 3, wherein the determining the first electronic brake control module fault comprises determining that the primary second brake torque target is not communicated in response to the braking request.

Clause 5. The system of clause 3, wherein the determining the first electronic brake control module fault comprises determining that the primary second brake torque target is a threshold percentage different than the alternative second brake torque target.

Clause 6. The system of clause 1, further comprising: the brake pedal.

Clause 7. The system of clause 6, further comprising: a master cylinder coupled to the brake pedal, wherein the master cylinder is configured to operate the first brake during a push through condition.

Clause 8. The system of clause 7, wherein the push through operation comprises pressing the brake pedal beyond a threshold distance to cause the master cylinder to build pressure.

Clause 9. The system of clause 1, wherein the first brake is a front brake, and wherein the second brake is a rear brake.

Clause 10. A vehicle comprising: a chassis; a first wheel/tire assembly coupled to the chassis; a second wheel/tire assembly coupled to the chassis; a pedal; a first pedal position sensor, configured to detect a position of the pedal and provide first pedal position data; a first brake configured to brake the first wheel/tire assembly; a first electronic brake control module, configured to: receive the first pedal position data; determine that the first pedal position data indicates a braking request; determine, based on the first pedal position data, a first brake torque target and a primary second brake torque target; operate the first brake based on the first brake torque target; and communicate, to a second electronic brake control module, the primary second brake torque target; a second brake configured to brake the second wheel/tire assembly; and a second electronic brake control module, configured to: receive the primary second brake torque target; and operate the second brake based on the primary second brake torque target.

Clause 11. The vehicle of clause 10, further comprising: a second pedal position sensor, configured to detect the position of the pedal and provide second pedal position data, wherein the second electronic brake control module is further configured to: receive the second pedal position data; determine that the second pedal position data indicates the braking request; and cross-check the second brake torque target based on the second pedal position data.

Clause 12. The vehicle of clause 11, wherein the second electronic brake control module is configured to: determine a first electronic brake control module fault; determine an alternative second brake torque target; and operate the second brake based on the alternative second brake torque target.

Clause 13. The vehicle of clause 12, wherein the determining the first electronic brake control module fault comprises determining that the primary second brake torque target is not communicated in response to the braking request.

Clause 14. The vehicle of clause 12, wherein the determining the first electronic brake control module fault comprises determining that the primary second brake torque target is a threshold percentage different than the alternative second brake torque target.

Clause 15. The vehicle of clause 10, further comprising: an electrical motor configured to propel the vehicle.

Clause 16. The vehicle of clause 10, wherein the pedal is a brake pedal, and wherein the vehicle further comprises: a master cylinder coupled to the brake pedal, wherein the master cylinder is configured to operate the first brake during a push through condition, the push through operation comprising pressing the brake pedal beyond a threshold distance to cause the master cylinder to build pressure.

Clause 17. The vehicle of clause 10, wherein the first brake is a front brake, and wherein the second brake is a rear brake.

Clause 18. A system comprising: a first electronic brake control module, configured to: receive first pedal position data from a first pedal position sensor; determine that the first pedal position data indicates a braking request; determine, based on the first pedal position data, a first brake torque target and a primary second brake torque target; operate a first brake based on the first brake torque target; and communicate, to a second electronic brake control module, the primary second brake torque target; and a second electronic brake control module, configured to: receive the primary second brake torque target; and operate the second brake based on the primary second brake torque target.

Clause 19. The system of clause 18, wherein the first brake is a front brake and the second brake is a rear brake.

Clause 20. The system of clause 18, the second electronic brake control module is further configured to: receive second pedal position data from a second pedal position sensor; determine that the second pedal position data indicates the braking request; and cross-check the second brake torque target based on the second pedal position data.

### BRIEF DESCRIPTION OF THE DRAWINGS

FIG. 1 illustrates a vehicle, in accordance with certain embodiments.

FIG. 2 is a block diagram of a commercial electric vehicle braking system, in accordance with certain embodiments.

FIG. 3 is another block diagram of a commercial electric braking system, in accordance with certain embodiments.

FIG. 4 is a diagram illustrating operation of a commercial electric braking system, in accordance with certain embodiments.

FIG. 5 illustrates various braking curves, in accordance with certain embodiments.

FIG. 6 is a flowchart detailing operation of a commercial braking system, in accordance with certain embodiments.

FIG. 7 is a flowchart detailing operation of a commercial braking system in response to an electric brake front module (EBFM) fault, in accordance with certain embodiments.

FIG. 8 is a flowchart detailing operation of a commercial braking system in response to an electric brake rear module (EBRM) fault, in accordance with certain embodiments.

FIG. 9 is a block diagram of a computer system, in accordance with certain embodiments.

FIG. 10 illustrates a brake module, in accordance with certain embodiments.

FIG. 11 is a flowchart detailing operation of a commercial braking system, in accordance with certain embodiments.

FIG. 12 is a flowchart detailing operation of a commercial braking system in response to an electric brake rear module (EBRM) fault, in accordance with certain embodiments.

FIG. 13 is a flowchart detailing operation of a commercial braking system in response to an electric brake front module (EBFM) fault, in accordance with certain embodiments.

FIGS. 14-16 is a graph illustrating a pedal travel to hydraulic pressure curve of commercial braking systems in various configurations, in accordance with certain embodiments.

### DETAILED DESCRIPTION

In the following description, numerous specific details are outlined to provide a thorough understanding of the presented concepts. The presented concepts may be practiced without some or all of these specific details. In other instances, well-known process operations have not been described in detail to not unnecessarily obscure the described concepts. While some concepts will be described in conjunction with the specific embodiments, it will be understood that these embodiments are not intended to be limiting.

It is appreciated that, for the purposes of this disclosure, when an element includes a plurality of similar elements distinguished by a letter following the ordinal indicator (e.g., “108A” and “108B”) and reference is made to only the ordinal indicator itself (e.g., “108”), such a reference is applicable to all the similar elements.

### INTRODUCTION

As noted above, brake-by-wire systems are controlled by an ECU, the failure of which may cause complete brake system failure. Typical brake-by-wire solutions provide for a hydraulic braking system back-up, but hydraulic braking systems do not provide for real-time bias adjustment.

Commercial vehicles may experience major weight changes during their operation. For example, commercial vehicles may be operated unloaded, partially loaded, or fully loaded. A trailer may be hooked to a commercial vehicle to transport additional loads. The weight changes may be sudden (e.g., loading 35,000 pounds in a trailer of a semi-truck) or incremental (e.g., delivering packages or collecting garbage). Furthermore, some weight changes may not be easily predictable (e.g., passengers leaving or entering a bus at the next bus stop). Due to the large variations in weight that a commercial vehicle may be operated at, as well as the corresponding changes in weight distribution, real-time bias adjustments may significantly increase the braking performance of such commercial vehicles.

### Vehicle Examples

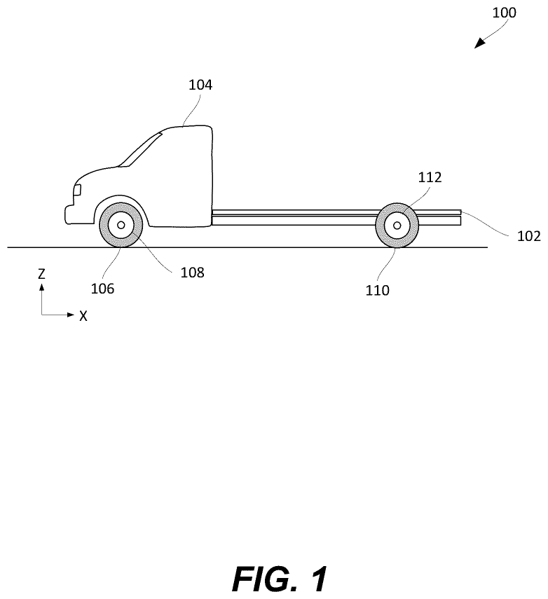

FIG. 1 illustrates a vehicle, in accordance with certain embodiments. FIG. 1 illustrates vehicle 100 that includes chassis 102, cab 104, front wheel/tire assembly 106 with front brakes 108, and rear wheel/tire assembly 110 with rear brakes 112. In certain embodiments, vehicle 100 may be a commercial vehicle with electric propulsion. Vehicle 100 may represent any type of commercial vehicle, such as a vehicle with an integrated cargo volume, (e.g., a delivery van or a box truck), a flatbed truck, a pickup truck, a truck with an enclosed cargo box, a towing vehicle, and/or any other such commercial vehicle. Front brakes 108 and rear brakes 112 may represent friction brakes of vehicle 100. In certain embodiments, vehicle 100 may additionally include regenerative braking on one or more axles (e.g., the axles associated with one or more wheel/tire assemblies that are powered). Regenerative braking may be performed by one or more electric motors that provide propulsive power to vehicle 100.

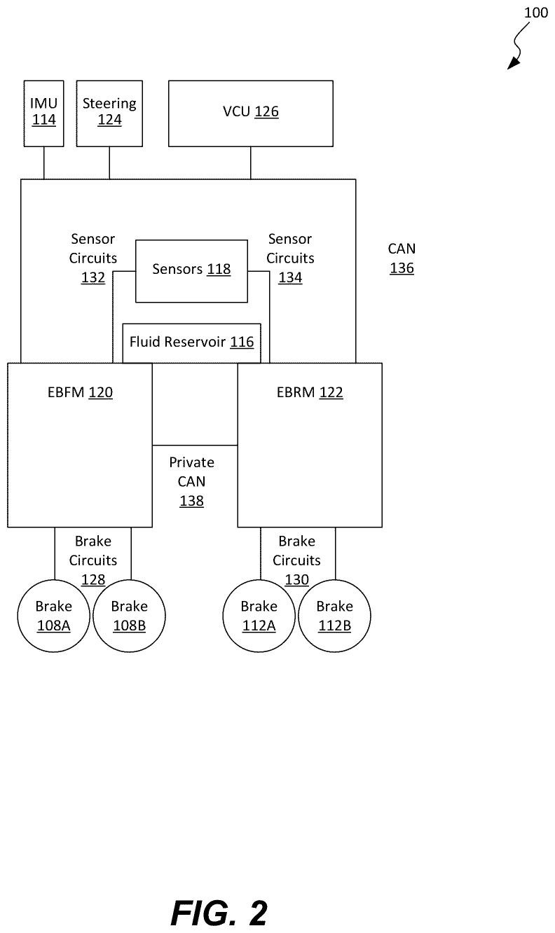

FIG. 2 is a block diagram of a commercial electric vehicle braking system, in accordance with certain embodiments. FIG. 2 illustrates a block diagram of vehicle 100. As illustrated in FIG. 2, vehicle 100 includes front brakes 108A and 108B (which may be separate friction brakes associated with wheel/tire assemblies on opposite ends of an axle), rear brakes 112A and 112B (which may also be separate friction brakes associated with wheel/tire assemblies on opposite ends of an axle), inertial measurement unit (IMU) 114, steering 124, vehicle control unit (VCU) 126, sensors 118, fluid reservoir 116, electronic brake front module (EBFM) 120 (“a first brake module”), and electronic brake rear module (EBRM) 122 (“a second brake module”).

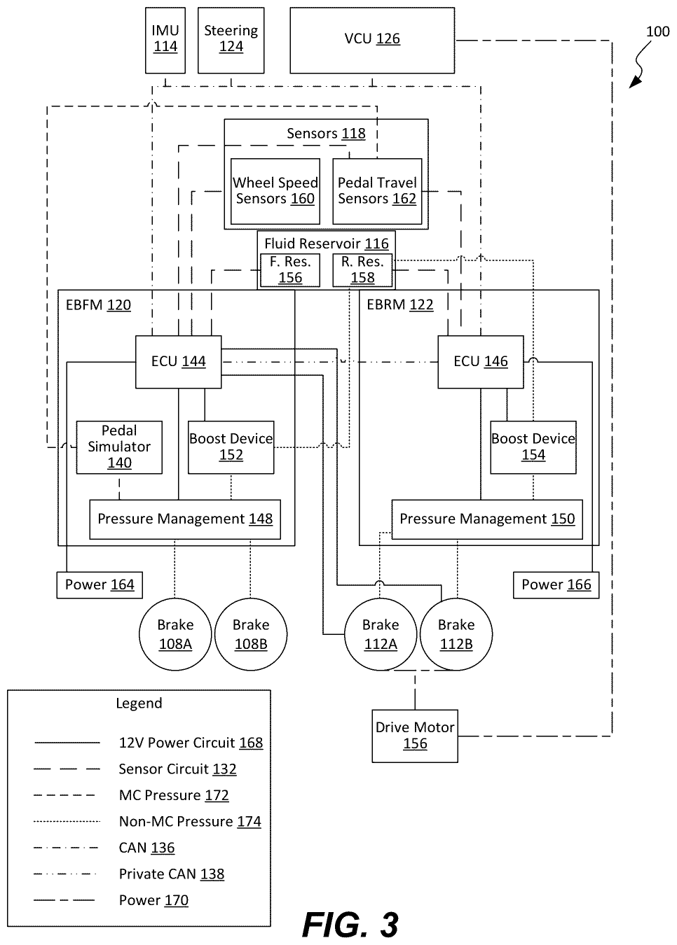

EBFM 120 and EBRM 122 may be physically separate brake modules. That is, each of EBFM 120 and EBRM 122 may include its own respective ECU (e.g., separate PCB board with processor), separate hydraulic cylinder for pressure management (e.g., pressure management 148 and 150 shown in FIG. 3), and separate boost control devices. In various embodiments, EBFM 120 and EBRM 122 may only be directly coupled via data connections, such as CAN data connections, and may not share hydraulic pressure lines. That is EBFM 120 and EBRM 122 may not share hydraulic fluid (e.g., brake fluid) for actuation of brakes. Additionally or alternatively, each processor of EBFM 120 or EBRM 122 may be configured to provide electrical signals to only the respective front brake 108 or rear brake 112 for actuation of front brake 108 or rear brake 112, respectively. In various embodiments, EBFM 120 and EBRM 122 may include processors that are dedicated to actuation of brakes (e.g., brake calipers) and are not configured to provide instructions for operation of other vehicle components, such as drive motors. In certain embodiments, EBFM 120 may be disposed within a front half or front ⅓ of vehicle 100 and EBRM 122 may be disposed within a rear half or rear ⅓ of vehicle 100.

IMU, steering 124, VCU 126, EBFM 120, and EBRM 120 may be communicatively coupled via Controller Area Network (CAN) circuitry 136. Sensors 118 may be communicatively coupled to EBFM 120 and EBRM 122 via sensor circuits 132 and 134, respectively. EBFM 120 and EBRM 122 may be communicatively coupled via private CAN 138. EBFM 120 may operate brakes 108A and 108B via brake circuits 128. EBRM 122 may operate brakes 112A and 112B via brake circuits 130.

In various embodiments, brakes 108A and 108B may be friction brakes on a forward axle of vehicle 100 (e.g., an axle forward of the midpoint of vehicle 100 such as that of front wheel/tire assembly 106) and brakes 112A and 112B may be friction brakes on a rearward axle of vehicle 100 (e.g., an axle behind the midpoint of vehicle 100 such as that of rear wheel/tire assembly 110). Variously, such brakes may be, for example, disc brakes, drum brakes, and/or other such friction brakes that may be separate from electric motors that provide propulsion to vehicle 100. In certain embodiments, brakes 108A/B and/or 112A/B may include normal friction brakes configured to provide stopping power to slow vehicle 100 during normal operation and/or parking or holding brakes that may be configured to hold vehicle 100 when vehicle 100 is at rest.

Brake circuits 128 and 130 may be hydraulic and/or electrical circuits that may actuate brakes 108A/B and 112A/B, respectively. Various embodiments of brake circuits 128 and 130 may include hydraulic lines, electrical circuitry, and/or other such mediums that may cause calipers, shoes, and/or other friction causing devices of brakes 108A/B and/or 112A/B to operate and, thus, provide stopping power.

EBFM 120 and EBRM 122 may be configured to control the operation of brakes 108A/B and 112A/B, respectively. EBFM 120 and/or EBRM 122 may include various circuitry, ECUs, mechanical devices, and/or software, as described herein. In various embodiments, EBFM 120 may operate brakes 108A/B as well as provide instructions to EBRM 122 to operate brakes 112A/B or operate brakes 112A/B by itself. EBRM 122 may operate brakes 112A/B. In various embodiments, EBRM 122 may operate brakes 112A/B based on instructions (e.g., target deceleration figures) provided by EBFM 120. Furthermore, EBRM 122 may detect (e.g., from a pedal travel sensor of sensors 118) that the operator of vehicle 100 has commanded deceleration of vehicle 100, but that a fault of EBFM 120 has caused EBFM 120 to fail to provide deceleration instructions to EBRM 122 (e.g., due to no instructions being communicated by EBFM 120). In such a situation, EBRM 122 may operate brakes 112A/B independent of commands from EBFM 120. Similarly, EBFM 120 may detect a fault of EBRM 122 and may operate brakes 112A/B independent of EBRM 122 (e.g., bypassing EBRM 122).

In various embodiments, EBFM 120 and EBRM 122 may be wired and/or wirelessly communicatively coupled via private CAN 138. Private CAN 138 may be a CAN data connection for providing data and/or commands between EBFM 120 and EBRM 122. Private CAN 138 may be configured to specifically provide braking related data and/or commands (e.g., operational commands from EBFM 120 to EBRM 122).

As used herein, “operate” may refer to mechanical and/or electrical operation of brakes. Thus, such brakes may be operated via electrical commands provided to calipers, shoes, other electrical motors that may operate (e.g., via electrical motors, actuators, hydraulic motors, and/or other such devices) friction causing devices, via mechanical techniques such as hydraulic pressure that may operate friction causing devices such as a cylinders within a caliper piston or brake shoes, and/or via mechanical leverage to, e.g., operate a cable actuated braking device.

Fluid reservoir 116 may be a fluid reservoir for brakes 108A/B and/or 112A/B. Such a fluid reservoir may include hydraulic brake (e.g., brake fluid) for operating friction brakes such as brakes 108A/B and/or 112 A/B. In various embodiments, fluid reservoir 116 may include a plurality of fluid reservoirs, such as, for example, a first fluid reservoir for brakes 108A/B and a second, separate, fluid reservoir for brakes 112A/B. In various embodiments, hydraulic fluid from fluid reservoir 116 may be managed by EBFM 120 and/or EBRM 122, to operate brakes 108A/B and/or 112A/B.

Sensors 118 may include one or more wheel speed sensors, yaw sensors, pedal travel sensors, wheel travel sensors, bump stop sensors, accelerometers, gyroscopes, position sensors (e.g., global position sensors), and/or other such sensors used for operation of vehicle 100. Sensors 118 may be configured to determine one or more operational characteristics of vehicle 100 and/or operator commands for operation of vehicle 100. Various sensors of sensors 118 may be communicatively coupled to EBFM 120 and EBRM 122 via sensor circuits 132 and 134, respectively. Sensor circuits 132 and 134 may be one or more wired or wireless data links configured to provide data and/or commands between sensors 118 and EBFM 120/EBRM 122. Sensor circuits 132 and 134 may communicate via any communication standard, such as CAN, proprietary sensor signals, and/or other such appropriate formats.

IMU 114 may be an inertial measurement unit that integrates accelerometers around one or multiple axes, gyroscopes, and/or other sensors to provide data associated with the orientation and/or movement of vehicle 100. For example, IMU 114 may be configured to measure acceleration along one or more axes, such as measuring the vertical acceleration immediately prior to reaching the bump-stop limit and/or with the current suspension settings, (e.g., to determine the braking torque being generated at each wheel based on suspension travel changes).

Steering 124 may be a mechanical steering mechanism and/or a steer-by-wire system. Steering 124 may provide directional controls to vehicle 100. In certain embodiments, steering 124 may include one or steering angle sensors to indicate the angle of the steering wheel turned by the operator of vehicle 100. The steering angle may be used as an input to aid in operation of the brakes of vehicle 100 (e.g., as data inputs to EBFM 120 and/or EBRM 122 to modify outputs from EBFM 120 and/or EBRM 122). Thus, for example, if a high steering angle is indicated, EBFM 120 and/or EBRM 122 may determine that the front wheels have more limited ability to decelerate, due to the traction of the front tires being used to help steer the vehicle. EBFM 120 may accordingly determine appropriate front and/or rear deceleration targets based on such determinations. EBRM 122 may, alternatively or additionally, determine appropriate rear deceleration targets based on the determinations or receive the rear deceleration target from EBFM 120.

VCU 126 may be a vehicle control unit configured to determine various aspects of the operation of vehicle 100. Thus, for example, VCU 126 may be communicatively coupled various sensors of vehicle 100 and may provide readings and/or determinations of operating characteristics (e.g., parameters such as a magnitude of a metric for sensing, and/or determinations as to the operating conditions, such as normal, limp, warm up, etc.) of various aspects of vehicle 100. For example, acceleration rates of vehicle 100 in one or more directions, torque values of motors, brakes, and/or applied to one or more wheels, pedal applications, motor regeneration data and/or torque values, drivetrain or gearing data, seatbelt and/or door status, parking brake settings, ambient temperatures, and/or fault statuses of vehicle 100. The various parameters determined by VCU 126 may be utilized in operation of vehicle 100, such as in the determination of brake bias by EBFM 120 and/or in determining the deceleration torque values for the respective brakes controlled by EBFM 120 and/or EBRM 122.

EBFM 120, EBRM 122, IMU 114, steering 124, and VCU 126 may be communicatively coupled via CAN circuit 136. CAN circuit 136 may be any appropriate data connection as described herein. CAN circuit 136 may, thus, allow for communication between IMU 114, steering 124, VCU 126, EBFM 120, and EBRM 122.

FIG. 3 is another block diagram of a commercial electric braking system, in accordance with certain embodiments. FIG. 3 illustrates vehicle 100 in further detail. As shown in FIG. 3, vehicle 100 further includes drive motor 156 from FIG. 2, which may be configured to provide propulsion to the wheel/tire assemblies associated with brakes 112A and 112B. Drive motor 156 may further provide regenerative braking for vehicle 100.

Power for operation of EBFM 120 may be provided via power source 164. Power source 164 may be a power source configured to power vehicle systems, such as a low-voltage power source. Similarly, power for operation of EBRM 122 may be provided via power source 166. Power source 166 may also be a power source configured to power vehicle systems, such as a low-voltage power source. In certain embodiments, EBFM 120 and EBRM 122 may be powered by the same power source, but in the embodiment of FIG. 3, EBFM 120 and EBRM 122 may include different power sources to provide redundancy.

As shown in FIG. 3, EBFM 120 may include ECU 144, pedal simulator 140, boost device 152, and pressure management 148. Vehicle 100 may include a brake pedal or a one pedal drive accelerator pedal that may be operated to provide braking commands to vehicle 100. Operation of such a pedal may cause pedal simulator 140 to provide feedback to the operator in a manner similar to that of a traditional hydraulic brake pedal. Pedal simulator 140 may provide such feedback based on the magnitude of movement of the pedal and/or the strength with which the brake pedal was pressed (e.g., based on readings from pedal travel sensors 162). Furthermore, pedal simulator 140 may include one or more valves that allow for the simulation of the feeling of hydraulic pressure. During normal operation, pedal simulator 140 may be operational and may simulate the feeling of pressing a hydraulic brake pedal, despite control of the brakes of the vehicle being completely by-wire. When a fault, such as an EBFM 120 fault, is detected, the valves may allow for pedal simulator 140 to be bypassed and for hydraulic pressure to be provided to one or more brakes (e.g., brakes 108A/B) directly, instead of being operated by-wire. In certain embodiments, such bypassing may allow for the brake pedal to, for example, hydraulically operate pressure management 148 and, thus, hydraulically operate brakes 108A/B (e.g., bypassing ECU 144) via brake fluid from fluid reservoir 116. Such an operation may occur when, for example, the pedal pressure applied may indicate an EBFM 120 fault.

ECU 144 may be an electronic control unit and may be configured to receive data from various components of vehicle 100 (e.g., sensors 118) and provide instructions for operation of brakes 108A/B as well as, in certain embodiments, brakes 112A/B. Thus, in certain embodiments, EBFM 120 may receive data from various sensors and determine a target brake torque distribution between front and rear axles, as well as any additional axles, as well as, in certain embodiments, brake torque distribution between wheels on different sides of vehicle 100.

Braking commands for vehicle 100 may be generated by a user through application of a brake pedal and/or through sufficient lifting off of an accelerator pedal, for embodiments where vehicle 100 is configured for one pedal drive. Such application or lifting may be determined by pedal travel sensors 162, which may detect when the user is commanding deceleration from vehicle 100. In certain embodiments, vehicle 100 may include a plurality of pedal travel sensors 162, where a first pedal travel sensor 162 is associated with EBFM 120 and provides pedal position data to EBFM 120 (e.g., may provide signals indicating braking commands from the operator to EBFM 120) while a second pedal travel sensor 162 is associated with EBRM 122 and provides pedal position data to EBRM 122. Accordingly, EBFM 120 and EBRM 122, which are physically separate brake control modules, may receive pedal position data from separate pedal travel sensors to allow for data verification.

ECU 144 may be coupled to pressure management 148 and/or boost device 152 to operate brakes 108A/B. In certain embodiments, pressure management 148 may include one or more hydraulic pressure management components that may, for example, dump or isolate hydraulic pressure, to properly operate brakes 108A/B. Thus, pressure management 148 may modulate the hydraulic pressure to cause friction causing devices (e.g., calipers or shoes) of brakes 108A/B to operate (e.g., through generation of hydraulic pressure) as desired (e.g., to avoid hydraulic pressure spikes that may otherwise cause unintentionally high levels of braking).

Boost device 152 may be communicatively coupled to ECU 144 to receive commands from ECU 144. Such commands may cause boost device 152 to operate (e.g., generate boost) and pressure management 148 to control the boost, in order to properly operate brakes 108A/B. Boost device 152 may, thus, be a hydraulic, vacuum, or other type of hydraulic booster configured to amplify hydraulic pressure. Such brake boosters, which may include one or more electric motors or actuators, may receive signals from ECU 144 and, based on the signals, be operated to cause the booster of boost device 152 to amplify hydraulic boost generated by pressure management 148.

Boost device 152 may be configured to amplify the hydraulic pressure generated by pressure management 148, to accurately operate brakes 108A/B. Pressure management 148 may include one or more hydraulic cylinders. One or more electric motors may, thus, receive signals from ECU 144 and, based on the signals, operate to cause the hydraulic cylinder(s) to build pressure. For example, the electric motor(s) may rotate an output shaft to attempt to compress or retract the hydraulic cylinder(s). As such, ECU 144 may provide data signals that cause the electric motor to operate or rotate in a specific direction. Rotation of the electric motor in one direction may cause hydraulic pressure to build, resulting in increased braking torque, and rotation of the electric motor in another direction may cause hydraulic pressure to decrease, resulting in decreased braking torque. The amount of hydraulic pressure generated by pressure management 148 may be adjusted based on operation of the electric motor (e.g., by turning the output shaft of the electric motor in a specific direction and/or via bleed valves that open or close within pressure management 148).

Thus, boost device 152 may be a power assist device, such as an electric or hydraulic brake booster, for pressure management 148, which may be a hydraulic cylinder. In various embodiments, ECU 144 may be separately communicatively coupled to both pressure management 148 and boost device 152. Accordingly, ECU 144 may typically operate boost device 152 to aid pressure management 148 to generate hydraulic pressure, to maximize the amount of pressure generated by pressure management 148. However, in the event of failure of boost device 152, ECU 144 may directly command pressure management 148 to generate hydraulic pressure.

EBRM 122 may include ECU 146, boost device 154, and pressure management 150. ECU 146, boost device 154, and pressure management 150 may be similar to ECU 144, boost device 156, and pressure management 148 described herein. While ECU 144 may be communicatively coupled to brakes 112A/B in addition to brakes 108A/B and, thus, may provide commands to operate brakes 112A/B, ECU 146 may be communicatively coupled to only brakes 112A/B. Accordingly, ECU 146 and, thus, EBRM 122 may be configured to only operate rear brakes 112A/B (e.g., may generate or provide hydraulic pressure and control signals for operation of brakes 112A/B). For embodiments where ECU 144 is communicatively coupled to brakes 112A/B, it is appreciated that ECU 144 may only provide signals to, for example, tune the actuation of the caliper pistons of brakes 112A/B and/or operate an electric parking brake (EPB) and may not provide hydraulic pressure.

ECU 144 and 146 may be communicatively coupled via private CAN 138. Thus, ECU 146 may determine when ECU 144 is faulty (e.g., when no signals are being communicated by ECU 144) and determine an EBFM 120 fault. In such a circumstance, ECU 146 may operate brakes 112A/B in a manner that assumes an EBFM 120 fault.

Brakes 108A/B and/or 112A/B may be electro-hydraulic brakes. Thus, the hydraulics of brakes 108A/B and/or 112A/B (e.g., the respective boost device or pressure management) may be electrically operated by the respective ECU (e.g., controlled by an electric motor that receives instructions from the respective ECU). Alternatively or additionally, for the purposes of this disclosure, it is appreciated that, in certain embodiments, brakes 108A/B and/or 112A/B may be electrically operated (e.g., may not include hydraulic components). In such embodiments, pressure management 148 may be replaced or supplemented by actuators, magnets, and/or other devices that may directly operate and generate hydraulic pressure to operate the friction causing devices of brakes 108A/B and/or 112A/B, instead of the pressure being generated by a hydraulic cylinder.

Fluid reservoir 116 may include separate front reservoir sensor 156 and rear reservoir sensor 158. Thus, the redundant brake fluid reservoirs may allow for continued braking ability in the event of failure of one of the fluid reservoirs or associated fluid lines and fluid reservoir sensors may determine such failures based on, for example, a decrease in brake fluid. The level of front reservoir fluid may be determined and communicatively provided to ECU 144 from front reservoir sensor 156 while the level of rear reservoir fluid may be determined and communicatively provided to ECU 164 from rear reservoir sensor 158. In certain embodiments, the rear reservoir may be fluidically coupled to boost devices 152 and 154. Thus, brake fluid may be provided and/or returned from boost devices 152 and 154 and, accordingly, the rear reservoir may hydraulically actuate boost devices 152 and 154 and, thus, hydraulically operate brakes 108A/B and 112A/B without commands from ECUs 144 and/or 146.

Wheel speed sensors 160N may determine the wheel speed of vehicle 100 and, thus, the speed that vehicle 100 is traveling at. The wheel speed, as well as other determined parameters such as the overall vehicle weight, weight distribution, and determined center of gravity location, may accordingly inform the brake bias selected for deceleration of vehicle 100 by EBFM 120.

Various components of vehicle 100 described in FIG. 3 may be coupled via 12V power circuit 168, sensor circuit 142, master cylinder hydraulic pressure line 172, non-master cylinder hydraulic pressure line 174, CAN 136, private CAN 138, and power connection 170, as shown in FIG. 3. 12V power circuit 168 and power connection 170 may provide electrical power to various components described herein. 12V power circuit 168 may be for operation of various accessories and for powering ECUs, while power connection 170 may be high voltage or amperage power for systems that require a large amount of electrical power, such as drive motor 156. CAN 136 and private CAN 138 may be data connections that provide data in accordance with the CAN format. CAN 136 may be CAN data provided and read by a variety of vehicle systems while private CAN 138 may be a private CAN connection for communication between only two systems (e.g., ECUs 144 and 146) for operation of a specific component category (e.g., brakes). Master cylinder hydraulic pressure line 172 and non-master cylinder hydraulic pressure line 174 may provide hydraulic pressure (e.g., brake fluid pressure) to various components of vehicle 100. It is appreciated that master cylinder hydraulic pressure line 172 may be coupled to only EBFM 120. Sensor circuit 132 may provide sensor data from one or more sensors to various ECUs, for determination of operational parameters of vehicle 100 and operational instructions thereof.

### Operation of Systems Examples

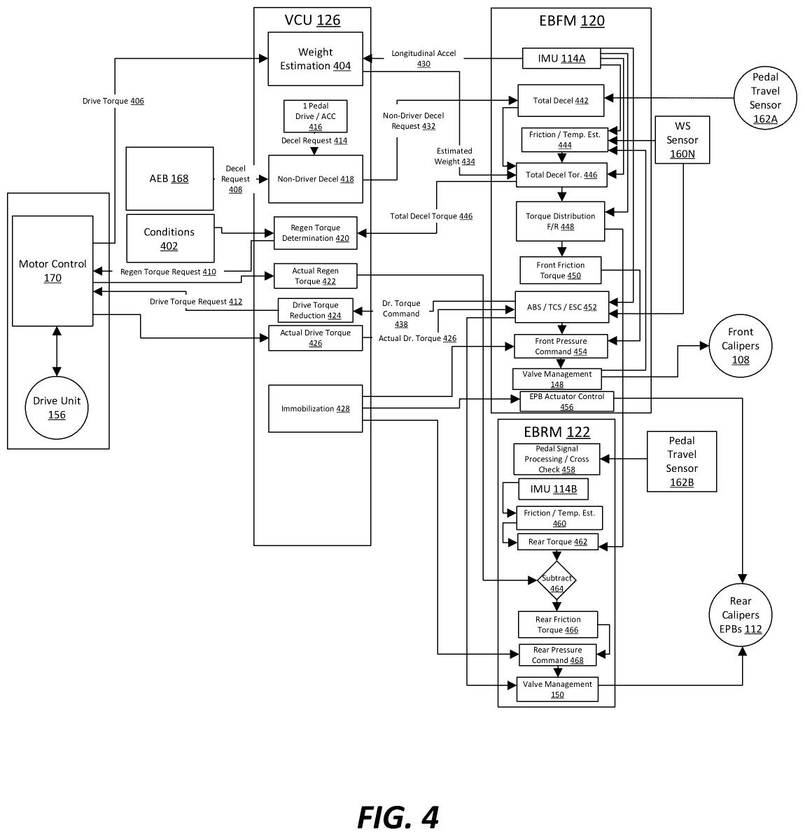

FIG. 4 is a diagram illustrating operation of a commercial electric braking system, in accordance with certain embodiments. FIG. 4 illustrates the operation of a commercial vehicle as described herein, such as vehicle 100. Various portions of FIG. 4 may be performed by components of vehicles described herein, including VCU 126, EBFM 120, EBRM 122, and other systems. As shown in FIG. 4, portions of the technique performed by various systems may be enclosed in the box of the respective systems.

Drive unit 156 may provide propulsion drive for the vehicle and motor control 170 may accordingly control the operation of drive unit 156. Drive torque 406 may be provided to the vehicle. IMU 114A may determine the longitudinal acceleration 430 of the vehicle and, based on drive torque 406 provided, may determine weight estimation 404, an estimation of the current loaded weight of the vehicle.

The operator of the vehicle may utilize the accelerator for 1 pedal drive. 1 pedal drive 416 may indicate the amount of deceleration through regeneration that the driver may desire. Additionally, the vehicle may include autonomous capability. Automatic emergency braking (AEB) 168 may be a drive aid or auto-drive module that may provide for autonomous, semi-autonomous, or computed aided operation of the vehicle. AEB 168 may, in certain situations, provide a deceleration request 408 (e.g., commanding for deceleration of the vehicle to, for example, avoid or mitigate a collision). Based on the regenerative braking desired via 1 pedal drive as well as deceleration request 408, if any, a non-driver deceleration request 432 may be determined in 418. In situations where AEB 168 is not providing a deceleration request and, thus, not attempting to autonomously operate the brakes of the vehicle, the non-driver deceleration request 432 is simply the regenerative braking commanded through the accelerator pedal. In situations where AEB 168 is requesting braking, non-driver deceleration request 432 may be a request with a deceleration rate higher than what could be provided through regenerative braking and, thus, may require application of friction brakes to fulfill.

Non-driver deceleration request 432 may be the component of deceleration that is not commanded by the operator via a brake pedal of the vehicle. Furthermore, the operator may provide a separate braking command via a brake pedal. Pedal travel sensors 162A and 162B may separately determine the amount of travel of the brake pedal and, thus, the amount of friction braking commanded by the operator. Other embodiments of pedal travel sensors 162A and 162B may be a single sensor with two channels. Based on data from pedal travel sensor 162A and non-driver deceleration request 432, a total deceleration 442 is determined by EBFM 120. Total deceleration 442 may be a blend based on the amount of friction brake deceleration commanded through the brake pedal and detected by pedal travel sensor 162A and the non-driver deceleration request 432. Thus, for example, pedal travel sensor 162A may detect travel of the brake indicative of a request for an amount of friction braking that exceeds the amount of deceleration in non-driver deceleration request 432. Such a situation may result in total deceleration 442 corresponding to the amount of deceleration requested by the travel of the brake pedal. Conversely, other situations may request in non-driver deceleration request 432 having a deceleration target higher than that of the friction brake application commanded by the brake pedals and, thus, total deceleration 442 may correspond to non-driver deceleration request 432. Other situations may blend non-driver deceleration request 432 and the friction braking requested by the brake pedal travel.

A plurality of wheel speed sensors 160N (e.g., disposed on one or a plurality of different wheels) may determine the wheel speed of the vehicle. Various sensor readings from IMU 114A, wheel speed sensor 160N, as well as feedback from operation of the brakes via valve management 148 (e.g., indicating whether lock-up events are occurring based on actuation of the front brakes) may allow EBFM 120 to determine a surface friction/temperature estimate 444. Furthermore, the sensor readings from IMU 114A and wheel speed sensor 160N, as well as other sensors, may allow for a determination of the center of gravity of the vehicle as well as an estimated weight (e.g., based on the compression of the suspension during static situations, which may indicate the weight of the payload of the vehicle, based on the compression and the known spring rate of the vehicle and/or through the detected grade of the surface, which may be determined through conditions 402, and longitudinal acceleration 430 from drive torque 406, as drive torque 406 would result in a specific longitudinal acceleration at specific grades).

The weight and/or center of gravity of the vehicle may also be determined based on the static suspension compression and the changes in suspension compression in dynamic motion. For example, as the wheelbase and width of the vehicle is known, the wheel speed sensor and/or accelerometer on the vehicle may allow for a determination of the acceleration or deceleration of the vehicle. For a given amount of acceleration or deceleration, the amount of suspension compression or decompression for the front and rear may be determined. As the spring rate is known, the amount of compression or decompression allows for a determination of the change in weight of a given axle for an amount of acceleration or deceleration. The center of gravity may then be calculated based on known equations. Such calculations may be performed a plurality of times for confirmation or to capture changes in the vehicle loading.

Based on the surface friction/temperature estimate 444, the estimated weight 434, sensor readings from IMU 114A, and the total deceleration 442, a total deceleration torque 446 may be determined. Total deceleration torque 446 corresponds to the total deceleration of the vehicle desired and/or possible based on operating conditions (e.g., state of the vehicle, the current conditions, the available grip due to the dynamic state of the vehicle).

Based on total deceleration torque 446, as well as data from IMU 114A, a front/rear brake torque distribution 448 may be determined. Front/rear brake torque distribution 448 may be a brake balance that allows for deceleration of the vehicle in a safe manner. Accordingly, for example, the front/rear brake bias may be a value that prevents instability of the vehicle (e.g., lock up and/or oversteer) and increases operator confidence and/or control. Based on front/rear brake torque distribution 448, front friction brake torque 450 for operation of the front brakes may be determined by EBFM 120 and EBFM 120 may determine and provide rear friction brake torque 462 to EBRM 122.

Additionally, EBRM 122 may conduct a cross check 458 of operation of the brake pedal via data from pedal travel sensor 162B. Such a cross check may allow for a determination of whether there is an EBFM 120 fault. IMU 114B may also allow for an estimation of surface friction/temperature estimate 460, which may also be a cross check of values determined by EBFM 120. In situations where EBRM 122 determines that there is an EBFM 120 fault, surface friction/temperature estimate 460 may be utilized to determine the rear friction brake torque 462 required to deceleration the vehicle.

In various embodiments, total deceleration torque 446 may also include or cause VCU 126 to determine a regenerative torque determination 420, which may be the regenerative braking component of total deceleration torque 446. In certain embodiments, the vehicle may include various sensors that are configured to determine operation conditions, such as ambient temperature, weather conditions, obstacles, grade, other external conditions, battery conditions, and/or other such conditions. Such conditions 402 may also inform the regenerative torque determination 420 (e.g., when a battery is fully charged or overheating, regenerative torque may be minimal). Regenerative torque determination 420 may result in a regenerative torque request 410 provided to motor control 170 and motor control 170 may operate drive unit 156 accordingly. Motor control 170 may then provide the actual regenerative torque 422, based on the regenerative torque determination 420.

In certain situations, drive unit 156 may provide drive torque (e.g., propulsive torque) to the vehicle. Motor control 170 may provide data indicating the drive torque to VCU 126. VCU 126 may determine an actual drive torque 426 outputted by drive unit 156. The actual drive torque 426 determined may be provided to anti-lock braking system (ABS)/traction control system (TCS)/electronic stability control (ESC) 452, which may be operated to ensure control of the vehicle. ABS/TCS/ECS 452 may provide drive torque command 438 which may request in drive torque reduction 424 determination by VCU 126, to maintain control of the vehicle, requesting in actual drive torque 426. The drive torque reduction may be communicated as a drive torque request 412 to motor control 170.

In certain situations, VCU 126 may determine that there is an immobilization request 428 for the vehicle. Immobilization request 428 may be a request for operation of the parking brake of the vehicle, through electronic parking brake (EPB) actuator control 456, to prevent vehicle movement.

Based on the front friction torque 450 and the ABS/TCS/ESC 452 determinations, a front pressure command 454 may be determined by EBFM 120. Front pressure command 454 may be a command for operation of the hydraulic systems to actuate the front brakes (e.g., front calipers 108) of the vehicle. In certain situations, ABS/TCS/ESC 452 may request a drive torque reduction; EBFM 120 may take into account the drive torque reduction requested when determining front pressure command 454 (e.g., front pressure command 454 may be reduced if it is determined that a portion of the braking may be provided by the reduction in drive torque). Front pressure command 454 may accordingly operate valve management 148, which may provide hydraulic pressure to front calipers 108 of the front brakes to accordingly provide front braking.

Referring back to EBRM 122, EBRM 122 may subtract 464 the rear braking provided by actual regenerative braking 422 from rear friction brake torque 462 to determine a rear friction brake torque 466. EBRM 122 may determine a rear pressure command 468 based on rear friction brake torque 466 and, in certain situations, immobilization 428. Thus, for example, if immobilization is requested, the electronic parking brake (EPB) may be actuated and, thus, the brake pressure applied to the rear calipers 112 may be accordingly adjusted. In other situations, a rear brake failure may be determined and the EPB may be accordingly operated to provide for rear braking. Rear pressure command 468 may accordingly operate valve management 150, which may provide hydraulic pressure to rear calipers 112 of the rear brakes to accordingly provide rear braking.

### Braking Curve Examples

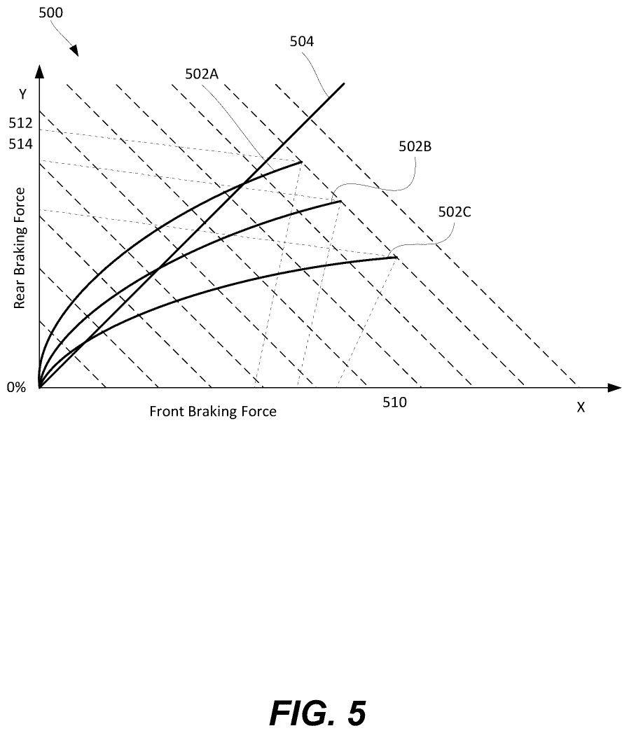

FIG. 5 illustrates various braking curves, in accordance with certain embodiments. FIG. 5 illustrates braking curve graph 500. The x-axis of braking curve graph 500 pertains to front braking force/torque. The y-axis of braking curve graph 500 pertains to rear braking force/torque. The intersection of the x and y-axis corresponds to no braking force generated by either the front or rear brakes. The diagonal broken lines represent vehicle deceleration achieved.

Braking curve 504 is the brake distribution if the same hydraulic pressure is applied to both the front and rear friction brakes. Braking curves 502A-C are ideal braking curves under different loading conditions. When a vehicle decelerates, the deceleration transfers weight to the front of the vehicle, increasing the relative amount of front braking force that vehicle 100 may generate. The ideal braking curves of braking curves 502A-C thus all increase the front braking force/torque in greater proportion than the rear braking force/torque as greater braking force is applied. The ideal braking curves may be brake force/torque distributions that minimize the stopping distance of the vehicle and may be determined based on the weight, center of gravity, tire grip, surface condition, and/or other aspects of the operation of the vehicle. Other braking curves may be possible and may be structured to allow for, for example, increasing driver confidence, maintaining a desired balance, and/or other such factors.

During operation, the EBFM 120 and/or EBRM 122 may select from any number of braking curves, including braking curves that are non-ideal. It is appreciated that the braking curves described in FIG. 5 is for illustrative purposes only and that any braking curve with any front/rear bias may be desired and/or generated by EBFM 120 and EBRM 122. For the purposes of this disclosure, EBFM 120 and/or EBRM 122 may dynamically determine and adjust the front/rear bias of the brakes of the vehicle. Accordingly, EBFM 120 and/or EBRM 122 may select from one of a plurality of different braking curves during operation of the vehicle.

### Operation Examples

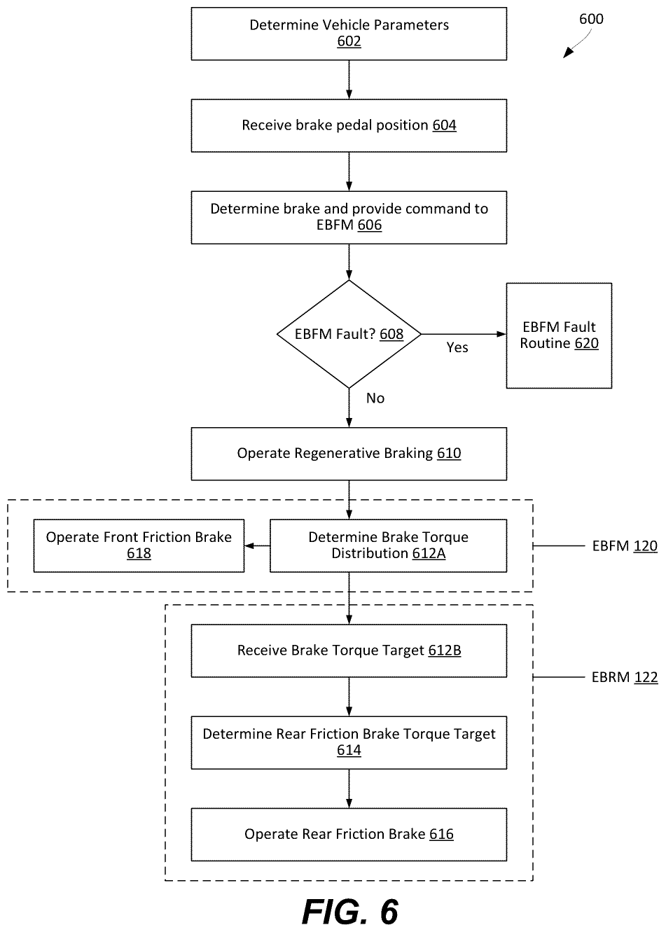

FIG. 6 is a flowchart detailing operation of a commercial braking system, in accordance with certain embodiments. FIG. 6 illustrates technique 600, which may be the braking technique used by a vehicle during normal operation. The vehicle utilizing technique 600 may include the systems and components described herein, including physically separate EBFM 120 and EBRM 122.

In 602, vehicle parameters may be determined according to the techniques described herein. For example, the various components of the vehicle, such as the pedal travel sensor, the brake modules, accelerometers, IMU, brakes, and/or other components may periodically output data. Based on the data, vehicle operation parameters such as velocity, acceleration, yaw, direction, location, and/or other parameters may be determined. In certain embodiments, vehicle parameters may be continuously determined by the vehicle while the vehicle is operated.

In 604, data directed to the brake pedal position may be received from one or more pedal travel sensors. The brake pedal position may indicate that the operator has requested braking from the vehicle. In 606, based on the brake pedal position, a braking command may be determined to have been requested by the operator of the vehicle. The braking command may be provided to, at least, the EBFM, for determination of the braking torques that would be provided by the brakes of the vehicle.

In 608, whether there is an EBFM fault may be determined. For example, if components of the braking system (e.g., the EBRM) fail to receive data and/or commands from the EBFM or the EBFM is otherwise uncommunicative, an EBFM fault may be determined. Alternatively or additionally, commands from the EBFM may be cross-checked (e.g., by the VCU and/or the EBRM) and, if a determination is made that the commands are outside the realm of reasonable (e.g., a threshold percentage, such as 30%, 50%, 70%, 100%, or another such percentage, or an order of magnitude different from what should be commanded, based on the vehicle parameters and the braking commanded), an EBFM fault is determined.

In certain embodiments, cross-checking may be performed by one, some, or all of the VCU, the EBFM, and the EBRM to determine if the brake pressure and/or bias determinations of the other of the EBRM or EBFM are accurate. For example, as each of the EBFM and EBRM ECUs may receive separate pedal travel data from separate pedal travel sensors, the amount of pedal travel may be determined and compared. If the pedal travel data indicates substantially similar (e.g., within 20%) brake pedal travel, each of the EBFM and EBRM ECUs may separately determine the total deceleration torque target and/or the friction brake torque target based on the operator commands, the sensor data from the vehicle (e.g., the determined weight and/or weight distribution), and/or the state of the vehicle. Each of the EBFM and EBRM ECUs may also determine the target front/rear bias. Furthermore, the VCU may also perform these calculations based on sensor data received from the various systems of the vehicle and/or from the ECUs of the EBFM and EBRM. The results may be accordingly compared with the determinations by the other ECUs/VCUs. If one module's determinations significantly deviates from that determined by the other modules, that module may be determined to be faulty.

Furthermore, the EBFM, the EBRM, and/or the VCU may include a range of realistic determinations for each determination. Thus, in a certain embodiment, the determinations of the ECUs of the EBFM and/or the EBRM may be output to the other of the EBFM or EBRM and/or to the VCU for confirmation or cross-checking. As an example, the amount of braking torque commanded by the vehicle may not realistically exceed a threshold amount, such as 0.5 g, 0.7 g, or 1 g of deceleration. If one of the ECUs provides a deceleration determination (e.g., based on the pedal travel), or commands a braking torque from the braking system that corresponds to an amount of vehicle deceleration (e.g., the deceleration torque generated by the braking system at each wheel that would result in such deceleration), that exceeds such a threshold amount, such as commanding 1.5 g of deceleration, then the corresponding EBFM or EBRM may be determined to be faulty. If an EBFM fault is determined, the technique may proceed to EBFM fault routine 620, which may be described elsewhere herein.

In various embodiments, the EBFM and EBRM may communicate data via private CAN. Additionally, EBFM and EBRM may both communicate data to the VCU via CAN data connections. Such data may indicate normal operation if data is received substantially on schedule (e.g., according to a pre-determined refresh rate, such as data packets every 0.5 seconds, 1 second, 5 seconds, or another refresh rate), if data indicating normal operation is received (e.g., period data pings indicating normal operation), if data received from the components matches that of other data received (e.g., data, such as wheel speed, that substantially matches the wheel speed data from other wheels over a period such as 5-10 seconds, such as data indicating wheel speed data within 25% of the other determined wheel speeds), and/or via other techniques. Absence of such data being received by the other of VCU, the EBFM, and the EBRM, such as if data is not received substantially on schedule, if data indicating normal operation is not received or if an error code is received from a certain component or module (such as EBFM or EBRM), if data received from a certain component or module significantly deviates from that of other data received (e.g., data with a 25% or greater magnitude difference from other data that is directed to measurement of the same aspect of vehicle operation), and/or via other techniques, may indicate abnormal operation and/or failure of one or both of EBFM or EBRM (e.g., if no data is received from EBFM or EBRM past a threshold amount of time, failure of EBFM and/or EBRM may be determined).

If any of those conditions are met, one of the EBFM or EBRM may declare an EBRM or EBFM fault for the other of the EBRM or EBFM, respectively. Furthermore, if no signals are communicated by one of the EBFM or the EBRM or if a fault message is communicated by the EBFM or EBRM, a EBFM or EBRM fault, respectively, may be determined. In another embodiments, the VCU may also be configured to determine EBFM or EBRM faults. In various embodiments, if a fault is determined with a first of the EBFM or EBRM, place the other of the EBRM or EBFM into another operating mode that accommodates such a fault. In certain embodiments, if one of the EBFM or EBRM does not receive data, receives an error message, or receives commands that are beyond the range of realistic from the other module, then the other module may be declared faulty and a different operating mode is selected. For such an embodiment, the non-faulty module may then communicate the determination of the faulty module to the VCU for confirmation or to configure all vehicle systems in accordance with the fault determination.

If no EBFM fault is determined, regenerative braking may first be utilized to decelerate the vehicle, in 610. If additional deceleration is needed beyond what regenerative braking can provide, or if friction brakes are needed for any other reasons (e.g., vehicle stability), EBFM 120 may determine the brake torque distribution in 612A, according to the techniques described herein, and operate the front brakes accordingly in 618. The brake torque distribution may be communicated to EBRM 122 and the EBRM 122 may accordingly receive the rear brake torque target in 612B.

Based on the rear brake torque target received, the rear friction brake torque target may be determined in 614. In certain embodiments, the regenerative braking may also be applied to the rear wheels and/or other types of deceleration or factors may be present. In such a situation, the rear friction brake torque target may be a percentage of the rear brake torque target received from the EBFM, to accommodate the other factors. Based on the rear friction brake torque target, the rear friction brakes may be accordingly operated in 616.

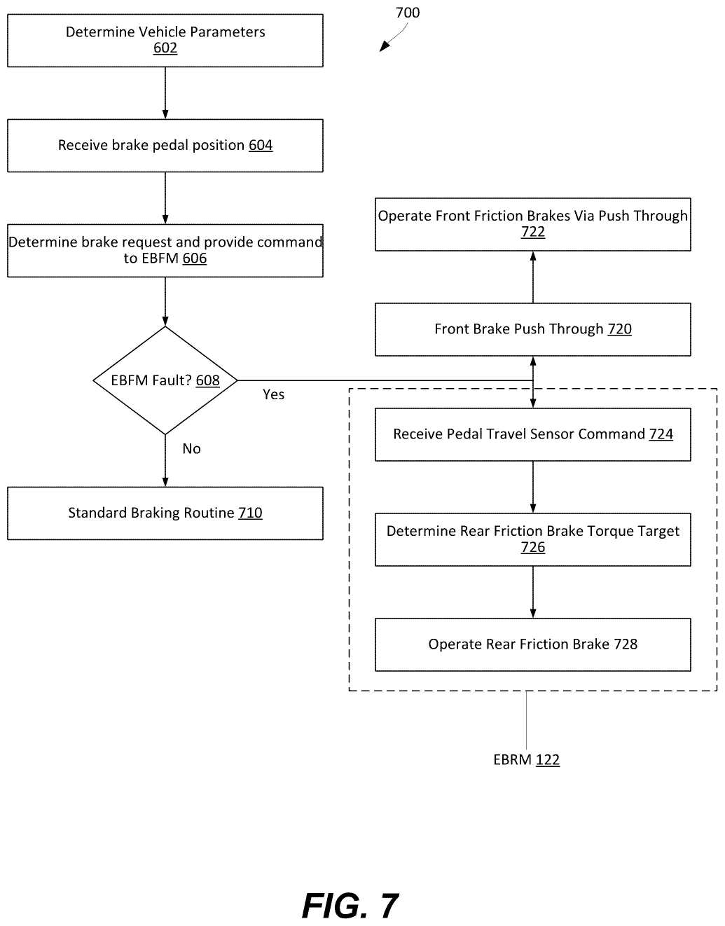

FIG. 7 is a flow chart detailing operation of a commercial braking system in response to an electric brake front module (EBFM) fault, in accordance with certain embodiments. FIG. 7 illustrates technique 700, which may be a braking technique used by a vehicle when there is an EBFM fault detected.

602, 604, and 606 may be similar to corresponding steps that are described in technique 600 of FIG. 6. If no EBFM fault is detected in 608, the brakes may be operated according to a first configuration and standard braking routine 710 may be performed. Standard braking routine 710 may include 610, 612A, 612B, 614, 616, and 618 of technique 600.

An EBFM fault may be detected according to the techniques described herein. For example, the EBFM fault may be determined based on a fault message communicated by the EBFM. Additionally or alternatively, the EBFM fault may be determined based on the EBRM, the VCU, or another module, ceasing receive data from the EBFM in accordance with a pre-determined schedule, based on data received from EBFM significantly deviating from that of data received from EBRM and/or other vehicle systems (e.g., EBFM may be communicating, for 5 seconds or longer, a wheel speed that deviates 25% or more from the wheel speed determination of EBRM or from other sensors of the vehicle), and/or via another technique.

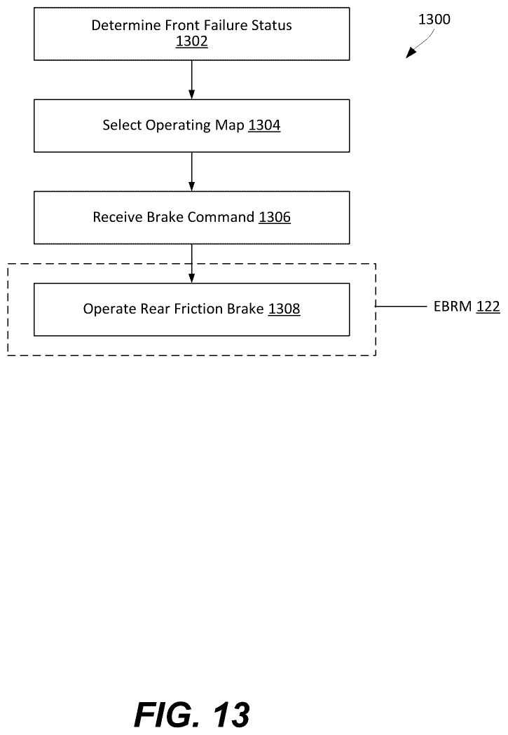

As the EBFM and the EBRM are physically separate modules that may be only communicatively coupled via data connections, if an EBFM fault is detected in 608, only the rear brakes may be electrically controlled by the EBRM. Accordingly, the brakes may be operated in a third configuration. Thus, EBRM 122 may receive pedal travel sensor data indicating that the operator is pressing on the brake pedal in 724. Based on the determination of the EBFM fault and that the operator is pressing the brake pedal, a rear friction brake torque target may be determined in 726 by the EBRM. In various embodiments, the rear friction brake torque target may be determined based on data from the IMU, regenerative braking, and/or other such data as described herein. In various embodiments, the rear friction brake torque target may be determined based on the assumption that front friction brakes will be operated through push through without electric control (as described in 720 and 722), while other embodiments may determine the rear friction brake torque target based on an assumption that the front brakes have failed and only rear brakes will be operated (e.g., in accordance with the technique of FIG. 13). Based on the rear friction brake torque target, the rear friction brakes may be operated in 728

In 720, a front brake push through may be determined. A front brake push through may involve the operator further pressing the brake pedal, to a region where the brake master cylinder is mechanically operated by the brake pedal. Thus, for example, the brake pedal may, for a first amount of travel, be electrically operating the brakes by providing signals indicating operation of the brake pedal to the EBFM and/or EBRM. When pushing through, the brake pedal may be pressed past the first amount of travel, into a region where the brake mastery cylinder is mechanically operated. In such a region, in 722, the front friction brakes may be operated via push through and, thus, through mechanical techniques such as the master cylinder.

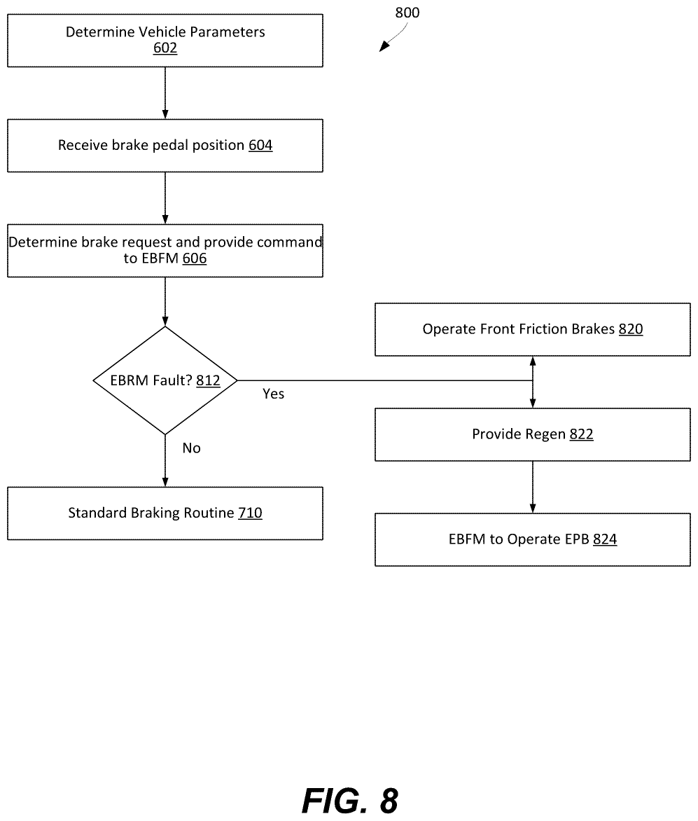

FIG. 8 is a flow chart detailing operation of a commercial braking system in response to an electric brake rear module (EBRM) fault, in accordance with certain embodiments. FIG. 8 illustrates technique 800, which may be a braking technique used by a vehicle when there is an EBRM fault. 602, 604, and 606 may be similar to corresponding steps that are described in technique 600 of FIG. 6.

In 812, a determination is made as to whether there is an EBRM fault. The EBRM fault may be determined according to techniques similar to that for determination of an EBFM fault. For example, if components of the braking system (e.g., the EBFM or the rear brakes controlled by the EBRM) fail to receive data and/or commands from the EBRM or the EBRM is otherwise uncommunicative, an EBRM fault may be determined. Thus, if the EBFM provides a braking command to the EBRM and there is no reply from the EBRM or no rear braking is detected, an EBRM fault may be determined. If there is no EBRM fault, the standard braking routine is performed in 710. 710 may be similar to corresponding 710 described in technique 700 of FIG. 7.

If an EBRM fault is detected, the brakes may be operated according to a second configuration of the braking system. Thus, the front friction brakes may be operated (e.g., by the EBFM, via push-through, or through another manner) in 820. In various embodiments, the front friction brakes may be operated normally (e.g., via EBFM) in 820. Meanwhile, regenerative braking may be applied in 822 to provide for rear braking. In certain situations, where the rear friction braking commanded by the EBFM is greater than the capacity for regenerative braking provided by the drive unit, full regenerative braking may be applied.

In certain embodiments, the EBFM may, alternatively or additionally, operate the electric parking brake (EPB) in 824 to provide rear braking to compensate for the EBRM failure. For example, the EBFM may be electrically coupled to the rear brakes or the EPB of the rear brakes via a 12V electrical circuit (as shown in FIG. 3). The 12V electrical circuit may allow for operation of the EPB. For example, 12V electrical power may cause an electric motor of the EPB to rotate and, thus, engage or disengage the EPB. The EBFM may thus communicate power to engage or disengage the EPB to provide rear braking as needed.

The EPB may provide for a pre-determined amount of braking torque (e.g., torque that corresponds to 0.1 g, 0.2 g, 0.3 g, 0.4 g, or 0.5 g of deceleration). The EBFM may, thus, engage the EPB if the amount of rear braking required exceeds the amount that regenerative braking can provide. As the EPB provides a set amount of braking, modulation of the rear brake torque may be accomplished through varying the amount of regenerative braking when the EPB is engaged.

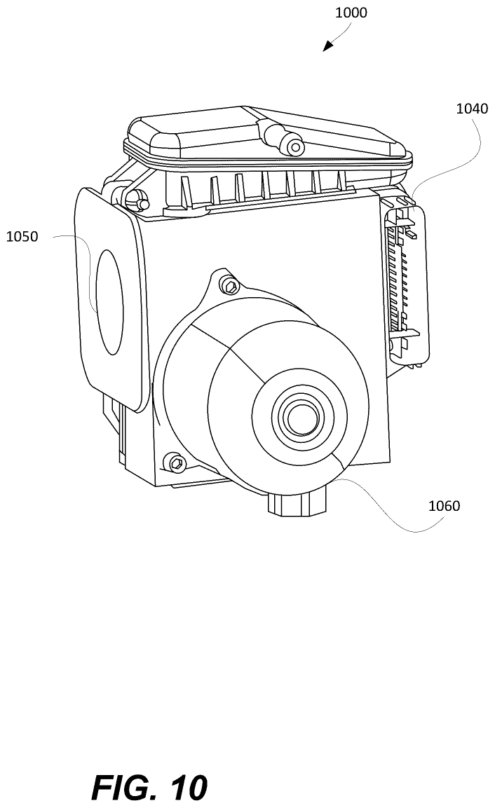

FIG. 10 illustrates a brake module, in accordance with certain embodiments. FIG. 10 illustrates brake module 1000, which may be an EBFM or an EBRM. As shown, brake module 1000 may be a self-contained module configured to operate one of the front brakes or rear brakes of a vehicle.

Brake module 1000 may include data processor 1040, pressure device 1050, and hydraulic pressure output 1060. Data processor 1040 may be an ECU that includes a data connection (e.g., a connector for coupling to a wire harness). Thus, data processor 1040 may be configured to control the front brakes and/or the rear brakes according to the techniques described herein.

Pressure device 1050 may be configured to generate and/or control hydraulic pressure for actuation of the brakes. Hydraulic pressure generated and/or controlled by pressure device 1050 may be output via hydraulic pressure output 1060 to the hydraulic components of the respective front or rear brakes (e.g., the respective calipers of the front or rear brakes).

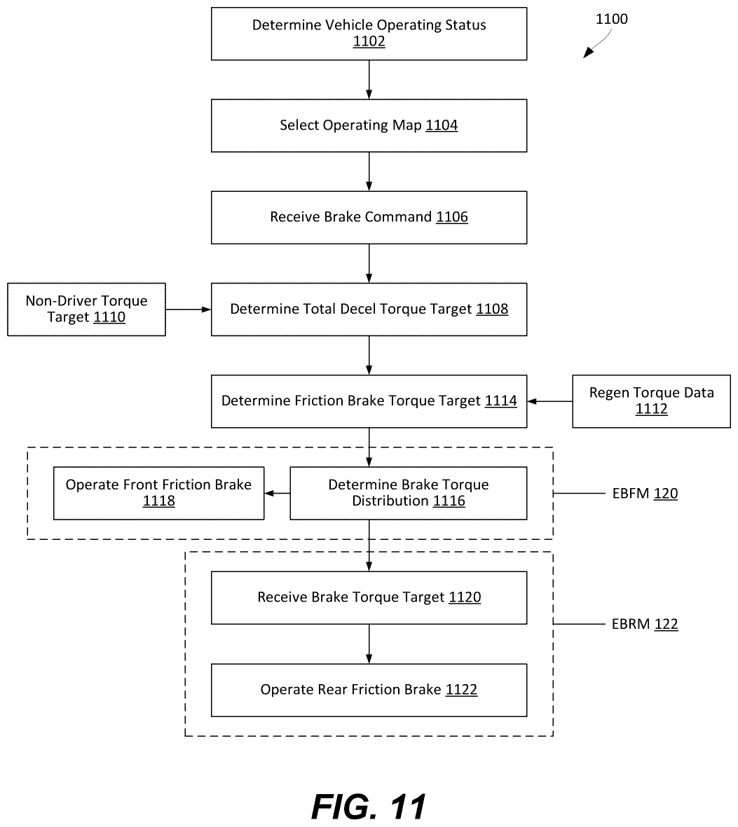

FIG. 11 is a flowchart detailing operation of a commercial braking system, in accordance with certain embodiments. FIG. 11 illustrates technique 1100 for operating the braking system of a commercial electric vehicle in normal operation.

In 1102, the vehicle operating status may be determined. In 1102, as part of the vehicle operating status determination, a determination may be made as to whether there is an EBFM or EBRM fault, according to the techniques described herein. In 1102 of technique 1100, no EBFM or EBRM fault may be detected. The braking system may, thus, be operated in a first configuration or a variation of the first configuration.

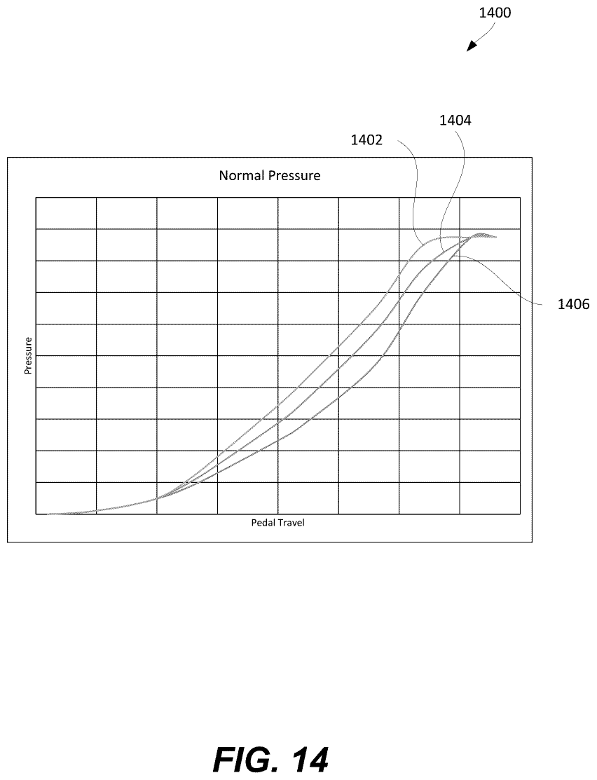

Based on the operating status, an operating map for the brakes may be determined in 1104. The operating map may be, for example, a map that correlates pedal travel (e.g., the amount of pedal travel detected by the pedal travel sensor) to hydraulic pressure generated by the braking system. An example of a map for normal operation is illustrated in FIG. 14.

In 1106, a braking command may be received from an operator of the vehicle. The braking command may be based on the operator pressing on a brake pedal or lifting off an accelerator pedal, to command deceleration of the vehicle. Pressing of the brake pedal may be determined by, for example, the pedal travel sensors described herein.

In 1108, based on the braking command provided in 1106, the total deceleration torque target is determined. The total deceleration torque target may be based on the pedal travel of the brake pedal and/or the amount of accelerator lift off. Thus, the greater the amount of accelerator lift off and/or the greater the amount of pressing on the brake pedal, the greater the total deceleration torque target. As such, the total deceleration torque target determined in 1108 is an estimate by the ECU of the vehicle or the ECU of the EBFM as to the amount of deceleration desired by the operator, based on the operator input.

The total deceleration torque target determined in 1108 may also include a non-driver commanded torque target 1110. The non-driver commanded torque target 1110 may be, for example, deceleration commanded by the VCU (e.g., for stability control). The non-driver commanded torque target of 1110 and the deceleration of the braking command of 1106 may be the components that make up the total deceleration torque target of 1108.

Deceleration of the vehicle may be provided by either friction brakes or through regeneration torque. In 1112, data indicating the amount of deceleration provided by power regeneration of the electric motor is provided to the EBFM. Such data may, for example, indicate the amount of electrical power generated (or consumed) by the electric motor. Based on the amount of electrical power generated (or consumed), the amount of deceleration (or acceleration) provided by the electric motor may be determined. Thus, for example, a certain amount of deceleration is provided by the electric motor to generate a certain amount of electrical power, and the relationship between deceleration and electrical power generated may be a curve (e.g., the greater the power generation, the greater the deceleration). Utilizing the stored curve may, thus, allow for the determination of the amount of deceleration provided by electrical power generation (“regen”) of the electric motor. Other example determination techniques may include, for example, utilization of accelerometers of the vehicle when no friction brake is applied.

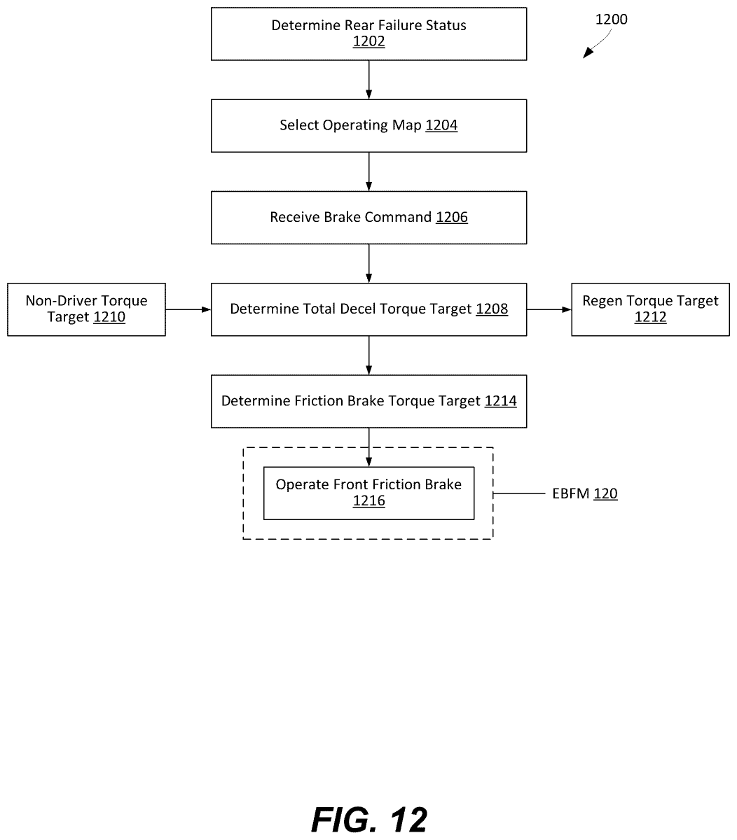

The amount of deceleration provided by regen that is determined in 1112 may be subtracted from the total deceleration torque target of 1108 in 1114 to determine the friction brake deceleration torque target. The friction brake deceleration torque target may be a deceleration torque target to be achieved in combination with all of the operational friction brakes of the vehicle. It is appreciated that 1102-1114, and their equivalents in FIGS. 12 and 13, may be performed by one, some, or all of the VCU, EBFM, or EBRM. In configurations where the VCU performs such techniques, the determinations from the VCU may be controlling (that is, may override the determinations of the EBFM and EBRM). In configurations where the EBFM and EBRM perform such techniques, the EBFM determination may be controlling unless an EBFM fault is determined, in which case the EBRM determination is utilized. Furthermore, in various embodiments for cross-checking, the determinations of the controlling module (e.g., VCU) may also be the controlling determination that the other results are cross-checked against and, if the other results deviate past a threshold amount, an EBFM or EBRM fault may be determined. In certain embodiments, regardless of which module is controlling, if a determination is made that a module is providing instructions that are beyond a realistic range, that module may be determined to be faulty. Thus, for example, even if EBFM results are controlling, if the EBRM determines that the EBFM is providing requests that are beyond the realistic range of deceleration that the vehicle can provide, the EBRM may communicate such a determination to the VCU and the VCU may declare that the EBFM is faulty and place the EBRM in control of the braking system.

As the vehicle includes both front and rear axles with friction brakes and the friction brake deceleration torque target is a total deceleration amount, a distribution of the amount of deceleration that should be provided by the front axle versus the rear axle is determined in 1116. In certain embodiments, the distribution may be a front/rear pressure distribution of the total pressure specified by the operating map selected in 1104. Thus, the operating map 1104 may be for a total system pressure and the total system pressure may be divided between the front and rear brakes according to the determined brake torque distribution.

The distribution may be, for example, a front versus rear deceleration ratio of 80:20, 60:40, 50:50, 40:60, or another such ratio. Such a ratio may be a set ratio or may be determined based on the detected weight of the vehicle (e.g., based on load, which may be determined by, for example, suspension travel sensors to indicate the amount of static suspension compression to extrapolate the weight on the axle), the inflation pressure of the tires of the axles, the determined amount of grip available (e.g., based on whether slip is detected at any of the wheels), and/or another such technique. Thus, for example, a more rearward ratio bias may be utilized if there is determined to be a large amount of rear load on the rear axle. Alternatively, if the vehicle is determined to be unloaded, a standard ratio (e.g., 50:50) may be selected.

In certain embodiments, the EBFM may determine the ratio of 1116. Based on the determined ratio, the EBFM may generate the amount of hydraulic pressure (e.g., with the boost device and pressure control, such as a master cylinder) needed to operate the front brakes to provide the deceleration commanded, in 1118. Operation of the front friction brakes may include adjustment of the hydraulic pressure to adjust the amount of deceleration, based on changes of driver input and/or sensor reading indicating, for example, insufficient or overly large amounts of deceleration provided by the front brakes.

Furthermore, the EBFM may provide the rear brake deceleration torque target to the EBRM. The EBRM may receive the rear brake deceleration torque target in 1120. In 1122, based on the rear brake deceleration torque target, the EBRM may generate the amount of hydraulic pressure (e.g., with the boost device and pressure control, such as a master cylinder) needed to operate the rear brakes to meet the rear brake deceleration torque target. Operation of the rear friction brakes may be adjusted as needed by the EBRM, similar to that of the EBFM.

FIG. 12 is a flowchart detailing operation of a commercial braking system in response to an electric brake rear module (EBRM) fault, in accordance with certain embodiments. FIG. 12 illustrates technique 1200, which may be a technique for operating the braking system of a commercial electric vehicle when an EBRM fault is determined.

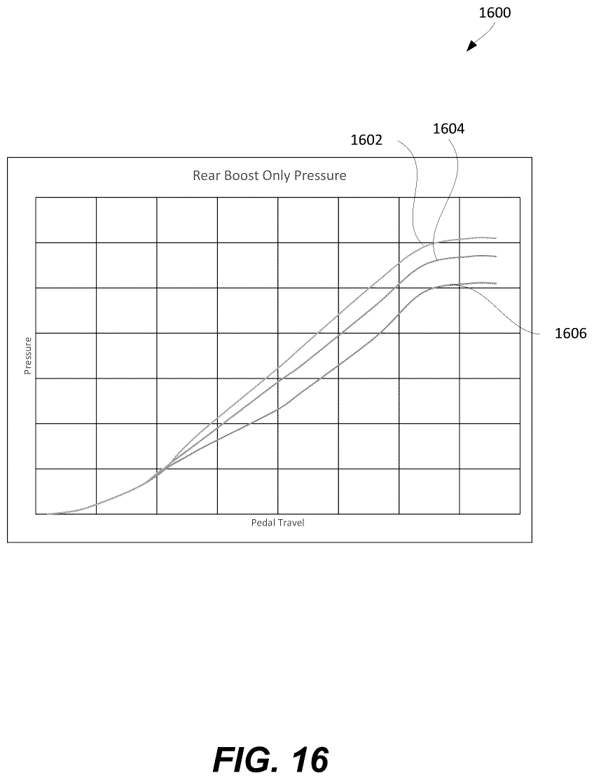

In 1202, the EBRM fault may be determined according to the techniques described herein. The braking system of the vehicle may accordingly be operated in a third configuration or a variation of the third configuration. Based on the EBRM fault, a front boost only pressure map may be selected. The operating map may be, for example, a map that correlates pedal travel (e.g., the amount of pedal travel detected by the pedal travel sensor) to hydraulic pressure generated by the braking system. The selected map may be for operation of the front brakes only. Thus, the hydraulic pressure may only be provided to the front brakes via the EBFM. An example of a front boost only pressure map is illustrated in FIG. 16.

In 1206, a braking command may be received from an operator of the vehicle. The braking command may be based on the operator pressing on a brake pedal or lifting off an accelerator pedal, to command deceleration of the vehicle. Pressing of the brake pedal may be determined by, for example, the pedal travel sensor.

In 1208, based on the braking command provided in 1206, the total deceleration torque target is determined. The total deceleration torque target may be based on the pedal travel of the brake pedal and/or the amount of accelerator lift off, similar to the technique of 1108. Thus, the greater the amount of accelerator lift off and/or the greater the amount of pressing on the brake pedal, the greater the total deceleration torque target. As such, the total deceleration torque target determined in 1208 is an estimate by the ECU of the vehicle or the ECU of the EBFM as to the amount of deceleration desired by the operator, based on the operator input.

Similar to that of 1110, the total deceleration torque target determined in 1208 may also include a non-driver commanded torque target 1210. Deceleration of the vehicle may be provided by either friction brakes or through regeneration torque. Unlike technique 1100, in technique 1200, the ECU of the vehicle or the EBFM may provide instructions to the electric motor for the amount of electric regeneration produced during deceleration (and, thus, the amount of deceleration torque produced by the electric motor). This is because, due to the EBRM failure, the rear friction brakes are inoperable. The EBFM thus provides instructions to the electric motor to control the amount of deceleration produced by the electric motor, in 1212. Such instructions may be, for example, CAN format instructions directed to the amount of electric power regeneration to be generated by the electric motor. In certain embodiments, the EBFM may provide data directed to such requests or instructions to the VCU. The VCU may then provide data including the appropriate instructions to the electric motor to operate the electric motor.

In 1214, the front friction brake torque target is determined. As regen will provide an amount of deceleration, the amount of deceleration provided by regen that is commanded in 1212 is subtracted from the total deceleration torque target of 1208 to determine the front friction brake deceleration torque target in 1214.

In 1216, based on the front friction brake torque target of 1214, the EBFM may generate the amount of hydraulic pressure (e.g., with the boost device and pressure control, such as a master cylinder) needed to operate the front brakes to provide the deceleration commanded. Operation of the front friction brakes may include adjustment of the hydraulic pressure to adjust the amount of deceleration, based on changes of driver input and/or sensor reading indicating, for example, insufficient or overly large amounts of deceleration provided by the front brakes.

FIG. 13 is a flowchart detailing operation of a commercial braking system in response to an electric brake front module (EBFM) fault, in accordance with certain embodiments. FIG. 13 illustrates technique 1300, which may be a technique for operating the braking system of a commercial electric vehicle when an EBFM fault is determined.

In 1302, the EBFM fault may be determined according to the techniques described herein. The braking system may accordingly be operated in a third configuration or a variation of a third configuration. Based on the EBFM fault, a rear boost only pressure map may be selected in 1304. The operating map may be, for example, a map that correlates pedal travel (e.g., the amount of pedal travel detected by the pedal travel sensor) to hydraulic pressure generated by the braking system. The selected map may be for operation of the rear brakes only. Thus, the hydraulic pressure may only be provided to the rear brakes via the EBRM. An example of a rear boost only pressure map is illustrated in FIG. 17.

In 1306, a braking command may be received from an operator of the vehicle. The braking command may be based on the operator pressing on a brake pedal or lifting off an accelerator pedal, to command deceleration of the vehicle. Pressing of the brake pedal may be determined by, for example, the pedal travel sensor.

In 1308, the EBRM may operate the rear brakes based on the operator command the map selected. Due to EBFM failure, regen may not be commanded/provided by the drive motor to allow for ease of operation and greater control to avoid inadvertent lock-up. As deceleration transfers weight forward to the front wheels and decreases available grip at the rear wheels, providing deceleration through only the rear friction brakes allows for greater fidelity in rear wheel deceleration control. Thus, the rear brakes may be operated according to the brake command received in 1306, the pedal pressure of which is mapped to the rear boost only pressure map selected in 1304. Accordingly, the EBRM may generate the amount of hydraulic pressure (e.g., with the boost device and pressure control, such as a master cylinder) needed to operate the rear brakes to provide the deceleration commanded. Operation of the rear friction brakes may include adjustment of the hydraulic pressure to adjust the amount of deceleration, based on changes of driver input and/or sensor reading indicating, for example, insufficient or overly large amounts of deceleration provided by the rear brakes.

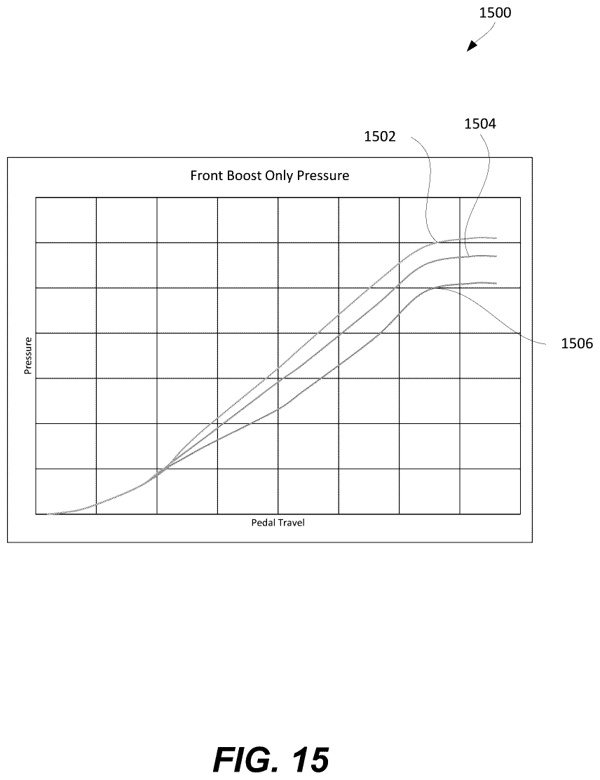

FIGS. 14-16 is a graph illustrating a pedal travel to hydraulic pressure curve of commercial braking systems in various configurations, in accordance with certain embodiments. FIG. 14 is a normal operating map that may be selected in 1104. FIG. 15 is a front boost only pressure map that may be selected in 1204. FIG. 16 is a rear boost only pressure map that may be selected in 1304.

The x-axes of FIGS. 14-16 correspond to pedal travel detected by the pedal travel sensor while the y-axes correspond to hydraulic pressure to be generated. Each of FIGS. 14-16 includes three separate curves, curves XX02, XX04, and XX06, with XX corresponding to the figure number. The three separate curves may correspond to different weights/weight distribution/or configurations of the vehicle.

### Computer System Examples

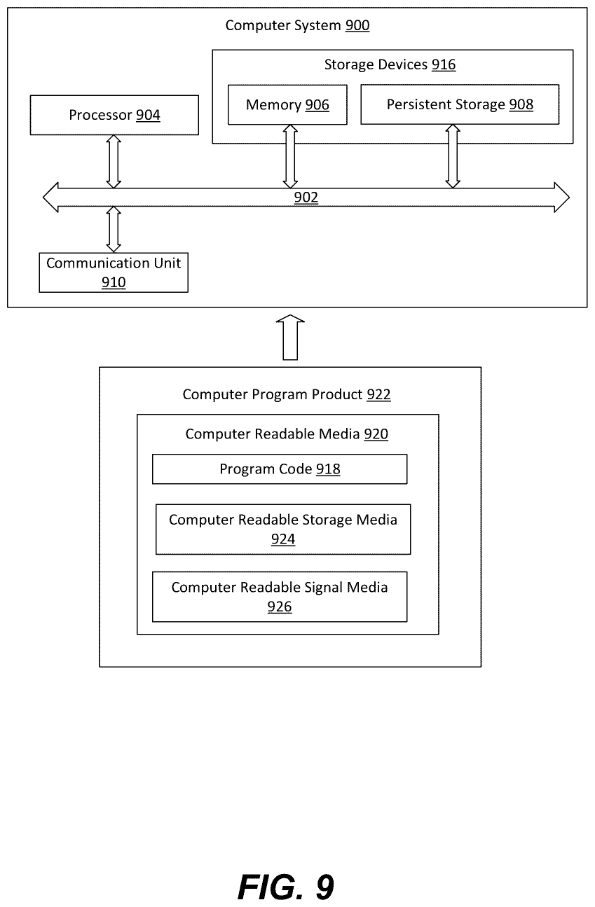

FIG. 9 is a block diagram of a computer system, in accordance with certain embodiments. In some examples, one or more components of computer system 900 are implemented as onboard components (e.g., ECUs) of vehicle 100. In various examples, computer system 900 includes communications framework 902 (e.g., a bus), which provides communications between processor unit 904, memory 906, persistent storage 908, and communications unit 910. Communications unit 910 provides for communications with other vehicle systems or devices. In these illustrative examples, communications unit 910 may be a network interface card (e.g., a CAN-bus device), universal serial bus (USB) interface, or other suitable communications device/interface.

Processor unit 904 serves to execute instructions for software that may be loaded into memory 906. Processor unit 904 may be a number of processors, a multi-processor core, or some other type of processor, depending on the particular implementation.

Memory 906 and persistent storage 908 are examples of storage devices 916, e.g., computer-readable storage components. Memory 906 may be a random access memory (RAM) or any other suitable volatile or non-volatile storage device. Persistent storage 908 may take various forms, e.g., a hard drive, a flash memory, or some combination of the above. Instructions for the operating system, applications, and/or programs may be located in storage devices 916. The techniques of the different examples may be performed by processor unit 904 using computer-implemented instructions, which may be located in a memory, such as memory 906.

These instructions are referred to as program code, computer usable program code, or computer-readable program code. The program code in the different examples may be embodied on different physical or computer-readable storage media, such as memory 906 or persistent storage 908. Program code 918 is located in a functional form on computer-readable media 920 that may be loaded onto or transferred to computer system 900 for execution by processor unit 904. Program code 918 and computer-readable media 920 form computer program product 922 in these illustrative examples. In one example, computer-readable media 920 may be computer-readable storage media 924 or computer-readable signal media 926.

In these illustrative examples, computer-readable storage media 924 is a physical or tangible storage device used to store program code 918 rather than a medium that propagates or transmits program code 918.

Alternatively, program code 918 may be transferred to computer system 900 using computer-readable signal media 926. Computer-readable signal media 926 may be, for example, a propagated data signal containing program code 918. For example, computer-readable signal media 926 may be an electromagnetic signal, an optical signal, and/or any other suitable type of signal. These signals may be transmitted over communications links, such as wireless communications links, optical fiber cable, coaxial cable, a wire, and/or any other suitable type of communications link.

### CONCLUSION

Although the foregoing concepts have been described in some detail for purposes of clarity of understanding, it will be apparent that certain changes and modifications may be practiced within the scope of the appended claims. It should be noted that there are many alternative ways of implementing the processes, systems, and apparatuses. Accordingly, the present embodiments are to be considered as illustrative and not restrictive.

What is claimed is:

1. A vehicle comprising:
a chassis;
a first wheel/tire assembly coupled to the chassis;
a second wheel/tire assembly coupled to the chassis;
an electric motor configured to power the second wheel/tire assembly;
a first pedal position sensor, configured to detect a position of a brake pedal and provide first pedal position data;
a first brake, configured to provide first deceleration torque to the first wheel/tire assembly;
a electronic brake front module (EBFM), comprising:
a first electronic control unit (ECU); and
a first pressure management device, electrically coupled to the first ECU and comprising a first hydraulic cylinder and a first electric motor, the first electric motor configured to, based on first electrical commands received from the first ECU, cause the first hydraulic cylinder to generate first hydraulic pressure to operate the first brake;
a second brake, configured to provide second deceleration torque to the second wheel/tire assembly and comprising a rear caliper and an electronic parking brake (EPB);
a electronic brake rear module (EBRM), physically separate from the EBFM and comprising:
a second ECU; and
a second pressure management device, electrically coupled to the second ECU and comprising a second hydraulic cylinder and a second electric motor, the second electric motor configured to, based on second electrical commands received from the second ECU, cause the second hydraulic cylinder to generate second hydraulic pressure to operate the second brake;
wherein, in a first configuration, the first ECU is configured to:
receive the first pedal position data;
determine that the first pedal position data indicates a first braking request;
determine, based on the first pedal position data, a first total deceleration torque;
determine a regen deceleration amount produced by the electric motor;
determine, based on the first total deceleration torque and the regen deceleration amount, a first brake torque target and a second brake torque target, wherein a total deceleration provided by a sum of the first brake torque target, the brake torque target, and the regen deceleration amount equals the first total deceleration torque;
electrically operate the first pressure management device to hydraulically operate the first brake in accordance with the first brake torque target; and
communicate, to the second ECU, the second brake torque target; and
wherein, in the first configuration, the second ECU is configured to:
receive the second brake torque target; and
electrically operate the second pressure management device to hydraulically operate the rear caliper of the second brake based on the second brake torque target.

2. The vehicle of claim 1, wherein the first ECU is further configured to:
determine an EBRM fault and place the EBFM into a second configuration.

3. The vehicle of claim 2, wherein, in the second configuration, the first ECU is configured to:
receive the first pedal position data;
determine, based on the first pedal position data, a first total deceleration torque;
determine a commanded regen deceleration amount;
determine, based on the first total deceleration torque and the regen deceleration amount, the first brake torque target;
cause the electric motor to operate according to the commanded regen deceleration amount; and
electrically operate the first pressure management device to hydraulically operate the first brake in accordance with the first brake torque target.

4. The vehicle of claim 3, wherein the determining the EBRM fault comprises:
determining a lack of data replies from the second ECU or receiving an error message from the second ECU.

5. The vehicle of claim 3, wherein a total deceleration provided by a sum of the first brake torque target and the commanded regen deceleration amount equals the first total deceleration torque.

6. The vehicle of claim 3, wherein the first ECU is electrically coupled to the EPB, and wherein, in the second configuration, the first ECU is further configured to:
operate, based on the first total deceleration torque, the EPB to generate an EPB deceleration torque, wherein a total deceleration provided by a sum of the first brake torque target, the EPB deceleration torque, and the commanded regen deceleration amount equals the first total deceleration torque.

7. The vehicle of claim 1, wherein the second ECU is further configured to:
determine a lack of commands from the first ECU or receive an error message from the first ECU; and
determine an EBFM fault based on the lack of commands or the error message; and
place the EBRM into a third configuration.

8. The vehicle of claim 7, wherein in the third configuration, the second ECU is configured to:
determine a second braking request;
determine, based on the second braking request, a third total deceleration torque; and
electrically operate the second pressure management device to hydraulically operate the second brake in accordance with the third total deceleration torque.

9. The vehicle of claim 8, further comprising:
a second pedal position sensor, configured to detect the position of the brake pedal and provide second pedal position data, wherein the second braking request is determined based on the second pedal position data, and wherein the third total deceleration torque is determined based on the second pedal position data.

10. The vehicle of claim 1, wherein the EBFM is disposed in a forward half of the chassis, and wherein the EBRM is disposed in a rearward half of the chassis.

11. A system comprising:
a first pedal position sensor, configured to detect a position of a brake pedal and provide first pedal position data;
a first brake;
an electric motor;
a electronic brake front module (EBFM), comprising:
a first electronic control unit (ECU); and
a first pressure management device, electrically coupled to the first ECU and comprising a first hydraulic cylinder and a first electric motor, the first electric motor configured to, based on first electrical commands received from the first ECU, cause the first hydraulic cylinder to generate first hydraulic pressure to operate the first brake;
a second brake, comprising a rear caliper and an electronic parking brake (EPB);
a electronic brake rear module (EBRM), physically separate from the EBFM and comprising:
a second ECU; and
a second pressure management device, electrically coupled to the second ECU and comprising a second hydraulic cylinder and a second electric motor, the second electric motor configured to, based on second electrical commands received from the second ECU, cause the second hydraulic cylinder to generate second hydraulic pressure to operate the second brake;
wherein, in a first configuration, the first ECU is configured to:
receive the first pedal position data;
determine that the first pedal position data indicates a first braking request;
determine, based on the first pedal position data, a first total deceleration torque;
determine a regen deceleration amount produced by the electric motor;
determine, based on the first total deceleration torque and the regen deceleration amount, a first brake torque target and a second brake torque target, wherein a total deceleration provided by a sum of the first brake torque target, the brake torque target, and the regen deceleration amount equals the first total deceleration torque;
electrically operate the first pressure management device to hydraulically operate the first brake in accordance with the first brake torque target; and
communicate, to the second ECU, the second brake torque target; and
wherein, in the first configuration, the second ECU is configured to:
receive the second brake torque target; and
electrically operate the second pressure management device to hydraulically operate the rear caliper of the second brake based on the second brake torque target.

12. The system of claim 11, wherein the first ECU is further configured to:
determine an EBRM fault and place the EBFM into a second configuration.

13. The system of claim 12, wherein, in the second configuration, the first ECU is configured to:
receive the first pedal position data;
determine, based on the first pedal position data, a first total deceleration torque;
determine a commanded regen deceleration amount;
determine, based on the first total deceleration torque and the regen deceleration amount, the first brake torque target;
cause the electric motor to operate according to the commanded regen deceleration amount; and
electrically operate the first pressure management device to hydraulically operate the first brake in accordance with the first brake torque target.

14. The system of claim 13, wherein the determining the EBRM fault comprises:
determining a lack of data replies from the second ECU or receiving an error message from the second ECU.

15. The system of claim 13, wherein a total deceleration provided by a sum of the first brake torque target and the commanded regen deceleration amount equals the first total deceleration torque.

16. The system of claim 13, wherein the first ECU is electrically coupled to the EPB, and wherein, in the second configuration, the first ECU is further configured to:
operate, based on the first total deceleration torque, the EPB to generate an EPB deceleration torque, wherein a total deceleration provided by a sum of the first brake torque target, the EPB deceleration torque, and the commanded regen deceleration amount equals the first total deceleration torque.

17. The system of claim 11, wherein the second ECU is further configured to:
determine a lack of commands from the first ECU or receive an error message from the first ECU; and
determine an EBFM fault based on the lack of commands or the error message; and
place the EBRM into a third configuration.

18. The system of claim 17, wherein in the third configuration, the second ECU is configured to:
determine a second braking request;
determine, based on the second braking request, a third total deceleration torque; and
electrically operate the second pressure management device to hydraulically operate the second brake in accordance with the third total deceleration torque.

19. The system of claim 18, further comprising:
a second pedal position sensor, configured to detect the position of the brake pedal and provide second pedal position data, wherein the second braking request is determined based on the second pedal position data, and wherein the third total deceleration torque is determined based on the second pedal position data.

20. The system of claim 11, wherein the EBFM is disposed in a forward half of a chassis of a vehicle, and wherein the EBRM is disposed in a rearward half of the chassis.
